(19) United States
(12) Patent Application Publication
(10) Pub. No.: US 2004/0062066 A1
(43) Pub. Date: Apr. 1, 2004

(54) Switched mode circuit topologies

(76) Inventor: Timothy Richard Crocker, Exeter (GB)

Correspondence Address: FISH & RICHARDSON, PC, 12390 EL CAMINO REAL, SAN DIEGO, CA, 92130-2081, US

(21) Appl. No.: 10/451,512

(22) PCT Filed: Dec. 21, 2001
(86) PCT No.: PCT/GB01/05694

(30) Foreign Application Priority Data
Dec. 22, 2000 (GB) 0031551.5

(51) Int. Cl. H02M 7/537

(52) U.S. Cl. 363/131

(57) ABSTRACT

In a first aspect, a switched-mode power supply circuit topology electrical power can be transferred between a source and a load across an antisymmetric transformer having a primary coil and a secondary coil. First and second switches are provided for respectively switchably coupling the primary coil across the source and the secondary coil, the switches being bi-directional. A controller controls the switches so that they can act synchronously with a predetermined mark-to-space ratio, which determines the voltage ratio between, the circuit topology comprises an inductor and is for transferring power between a source and a load, a common rail coupling one voltage terminal of the source and one voltage terminal of the load. Bi-directional switches are controlled to couple the ends of the inductor to the voltage terminals of the source and the load to control the power transfer.

This invention relates to switched mode circuit topologies and, in particular, to such topologies for use in reversible power supplies.

‘Switched mode’ is a term that is normally used to describe the very important group of electronic circuits, “Switched Mode Power Supplies” (SMPS). However the designs described in this application, although exactly falling into the ‘Power Supply’ grouping, have properties that take them into other groups, offering considerable advantages, and new application areas, hence the use of the more generic term “Switched Mode Topology” herein.

### Review of Terminology and Classification

### Power Supplies

Switched mode designs are increasingly taking over from the previous generation of “Linear Power Supplies” (LPS).

The principal technical advantages of SMPS are increased power efficiency and reduction of weight and size, whereas LPS still offer very much lower electrical noise. In manufacture there is a cost balance; LPS designs are simpler and the parts will have been cheaper, however the parts cost balance is now probably the other way, and modern manufacturing techniques overcome the inherently greater complexity of SMPS.

Both of these circuit groups are just power supplies, their function is to take in electrical power in one condition and produce a source of power to the voltage power and noise levels desired by a particular application. These supplies can be divided into three groups. LPS circuits achieving the same-output and function are only available for (a) and (b) below.

### a. AC to DC Supplies

These are nearly all employed to take an AC mains supply and produce one or more DC supplies. Mains powered supplies are also sometimes called “Off-Line” supplies, although there is an indication that this term has a slightly variable meaning, sometimes being used to describe “Direct Off Line” inductorless designs.

### b. DC to DC Down Converters

These take a higher voltage DC supply (sometimes from a battery bank) and produce one or more DC supplies for equipment, as in (a) above

### c. DC to DC Up Converters

These take a lower voltage and produce a higher one. In modern usage these are often used to produce small currents at higher voltages, for instance where the primary supply to a circuit is at SVDC, but a supply at 12VDC is needed by some components. In some senses this group of circuits has been around the longest, in the HT generators of TV sets and valve radios.

In all of these designs the main circuit feature is that current from the source flows intermittently through an inductor or transformer, and that, since current flow is controlled by an inductance, there is no intrinsic power loss as there is in LPS where excess voltage is reduced to the desired output level by dissipation as heat in resistors and semiconductors.

There are however several other groups of electronic circuits, where the novel designs described here will have application, and which use switching techniques, although there may be theoretical differences in the way the switching is used, or in its primary purpose.

### Motor Drives and Inverters

Motor drives still mainly use simple Pulse Width Modulation in which the current to the motor is simply switched on and off. There are many variations and the mechanism of control will vary with the implementation.

The details of PWM operation are not a direct concern of this patent application. However, it will be important to understand that ‘prior art’ citing PWM for motor control relies on different techniques, despite considerable circuit similarity. An important difference is the presence or absence of a ‘free-wheel’ diode or a component with the same function.

There are also drives for stepper motors. Stepper motor windings have inductance, and a common technique is to use a supply with a voltage high enough to get full current flowing through the coils (current rise time controlled by the winding inductance and applied voltage) in a time very much shorter than the coil ON time at maximum speed. The drive circuits then use a switching technique to limit the coil current, and minimise drive power consumption.

The term ‘inverter’ has previously been used to describe any circuit that took a DC source and made anything else from it by use of switching devices and a transformer or inductor (ie both AC and DC outputs). Increasingly the usage is that inverter means an AC output, and the term “DC to DC converted” is used for something that produces a DC output. An example of an inverter would be a device that produced an AC mains voltage supply from a vehicle DC supply.

The term inverter now also covers those circuits and drives that have a primary mains AC source, produce from this by direct rectification an intermediate (medium voltage) DC reservoir, and then create single or multiple phase AC output. The most common purpose is to control an AC induction motor by variation of the frequency of the AC output. Alternatively such circuits can be used to produce three-phase supplies from a single phase source.

### Power Amplifiers

There are a number of applications that now use switching techniques which are classed as ‘Power Amplifiers’ because of the nature of the linear circuit that they are replacing.

### SUMMARY OF THE INVENTION

The invention provides, in its various aspects, circuits or circuit topologies, and methods for operating circuits or circuit topologies, as defined in the appended independent claims. Preferred or advantageous features of the invention are defined in dependent subclaims.

In a first aspect, the invention may thus provide a reversible power supply circuit topology for transferring electrical power across an antisymmetric transformer, current through the primary and secondary transformer coils being synchronously switched by bi-directional switches in series with the primary and secondary coils respectively. Preferably the switches are MOSFETs (metal oxide semiconductor field effect transistors).

The circuit topology may advantageously operate in both step-down and step-up modes.

Advantageously, the output voltage of the circuit topology is controlled substantially only by the mark-to-space ratio of a control signal for operating the switches, under all operating conditions of the circuit. The mark to space ratio control alone may advantageously move the circuit continuously through the step-up and step-down modes. In a preferred aspect, the winding ratio of the transformer may be selected to match the voltage ranges over which a particular circuit has to operate: the winding ratio advantageously acts multiplicatively with the mark-to-space ratio. Thus if one side of the system works over a wider voltage range than the other, its side of the transformer may be advantageously wound with more turns

This aspect of the invention is embodied below as topology “T” (transformer).

In a second aspect, the invention may thus provide a reversible power supply circuit topology for transferring electrical power through an inductor from a source to a load, the source and the load being synchronously switched to each end of the inductor by half bridges of bi-directional switches. Preferably the switches are MOSFETs.

Advantageously the circuit topology is symmetrical about the inductor so that it can operate fully reversibly with respect to a source and a load.

This aspect of the invention is embodied below as topology “L” (inductor).

Whilst the circuit topology of the first aspect of the invention differs in structure from that of the second aspect of the invention, it will be seen that there are many parallels in the principles of operation. For practical purposes a major distinguishing characteristic is that in the first aspect of the invention the input and output sides can advantageously be electrically isolated by virtue of the use of the transformer windings.

Use of circuits with inductors and capacitors in topologies similar to these is known, for instance from U.S. Pat. No. 3,986,097 (Woods) for topology “T” and JP 044038192A (Masayuki and Motosumi) for topology “L”.

However all of these circuits use bipolar transistors with anti-parallel flyback diodes as the switching elements. A property of bipolar transistors is that when they are switched on they can only sustain current in their conventional direction of conduction. Any reverse current that needs to flow within that circuit has to flow in the anti-parallel diode, and for this to happen the circuit has to provide a voltage such that the diode is forward biased into conduction.

The present invention shows how fundamental improvements to both these related topologies may be made by the use of bi-directional switches, which here mean those that when switched ON can sustain current flow in either direction, independently of the state of drive to any control terminals (GATE, BASE, etc). MOSPET (Metal Oxide Semiconductor Field Effect Transistors) are the only semiconductor switches at present available which exhibit the necessary properties: when they are biased ON their condition channel will allow current to flow both in the conventional and the opposite directions. However the improvements over the prior art offered by this invention would be realised by any future semiconductor technology with similar properties. The advantages are described below.

Advantageously, in both topologies, a simple Pulse Width Modulated (PWM) non-overlapping control drive to the switching elements may establish a voltage ratio between input and output sides that is essentially independent of direction of current flow and which provides good control of that ratio in an ‘open-loop’ mode. Here, ‘open-loop’ has the conventional meaning in the context, that of control without need of a feed-back mechanism. Circuits of this design can use feedback to further refine levels of output control if need be: any such control may however be simplified due to the underlying stability of these topologies.

Advantageously, in its various aspects, the invention may provide improved power efficiency over prior art circuits, due in part to elimination, or the reduction of the duration, of current conduction through diodes and the intrinsic power loss of such conduction due to the forward diode voltage drop, and may simplify circuit control by permitting bi-directional current flow through switching elements.

In further aspects of the invention, improvements to the circuit topologies of the first and second aspect, and to other circuit topologies, are provided in the form of regenerative snubbers. These may advantageously protect semiconductor switching elements in power supplies from voltage transients while recovering at least a portion of the energy in those transients.

In an alternative aspect, the invention may also provide the following advantage. In conventional, usually older, up-converting designs the output voltage relationship to the input voltage would be fixed by design, operating in an ‘open-loop’ mode where the controlling drive signals were fixed. However as electronic control has become more sophisticated it has become common to add voltage control feedback (thus operating in a ‘closed loop mode’), where the circuit monitors its output voltage and automatically adjusts the control signals to produce the desired output voltage. This allows designs where there need not be a fixed relation between control signals and output voltage, for instance the output voltage might be load dependent. The invention may advantageously provide circuits in which the control signals have a direct relationship to the input/output voltage ratio. Such circuits offer intrinsic advantages because of this feature, particularly under conditions where the load changes. In many applications these circuits can be operated in an open-loop mode. Where voltage control feedback is used it may advantageously refine levels of output voltage control, rather than be used to stabilise an otherwise unstable output voltage.

The circuits of the various aspects of the invention may advantageously be used in a wide range of applications. By. way of example only, a non-limiting set of possible uses with reference to the foregoing discussion of existing circuit types would include the following.

The new topologies described here could advantageously be used to work directly from a lower supply voltage to drive a high voltage rated stepper motor (for instance a 72 volt rated motor could be driven from a 12 VDC vehicle supply).

The new topologies may allow alternative circuits performing the same functions as existing inverters.

The novel circuits described here may find application alongside or replacing power amplifiers, incorporating an inductor or transformer as current control element.

In summary, circuits of the invention may find applications far wider than switched mode power supplies, although that category would undoubtedly be their main home. Throughout this text the more generic “Switched Mode Topology” is used to encompass the widest application area.

Further aspects and advantages of the invention are set out within the specific description below.

### DESCRIPTION OF SPECIFIC EMBODIMENTS AND BEST MODE OF THE INVENTION

Specific embodiments of the invention will now be described by way of example, with reference to the drawings in which:

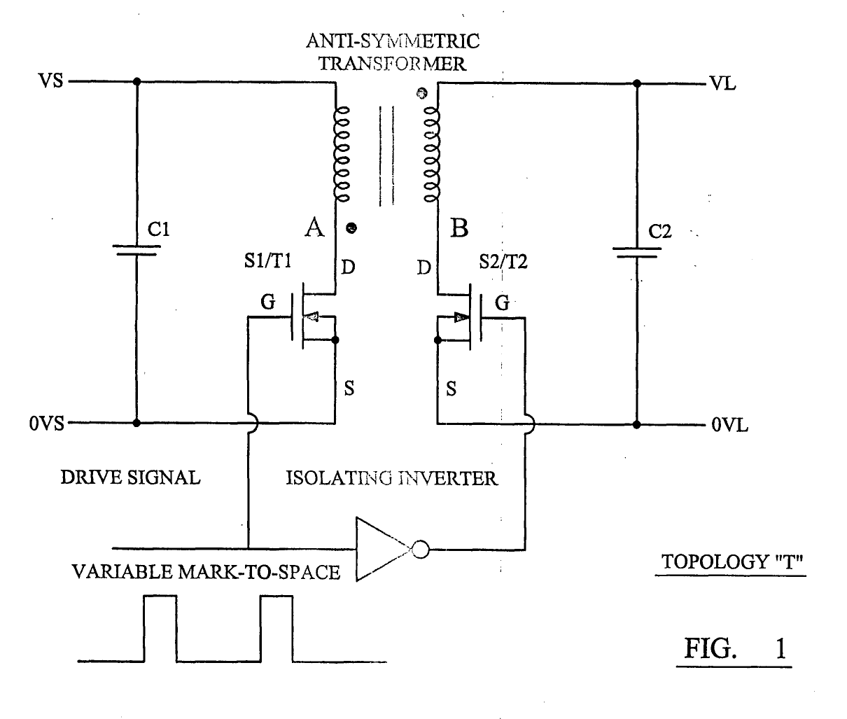

FIG. 1 is a circuit diagram of a first embodiment of the invention, topology T;

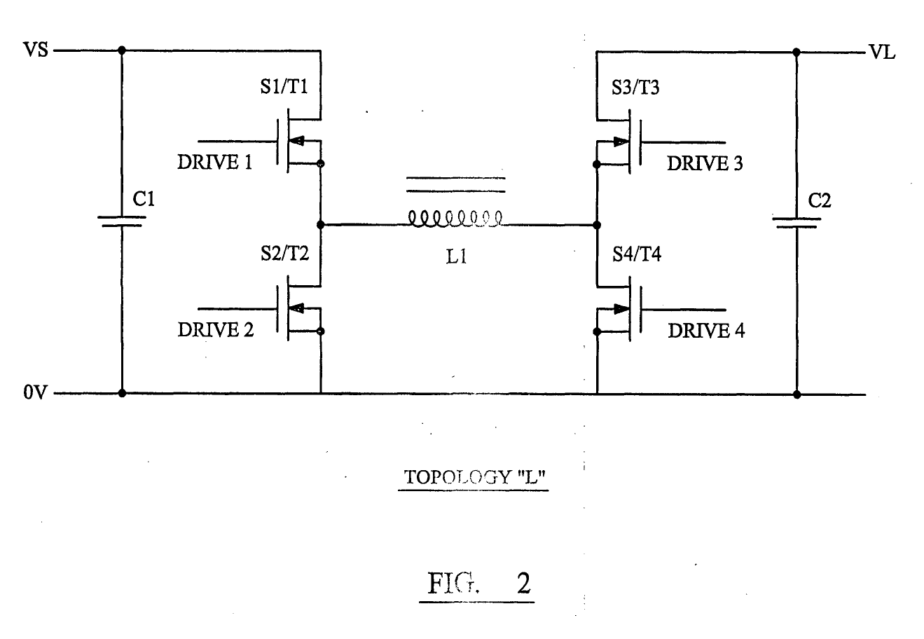

FIG. 2 is a circuit diagram of a second embodiment, topology L;

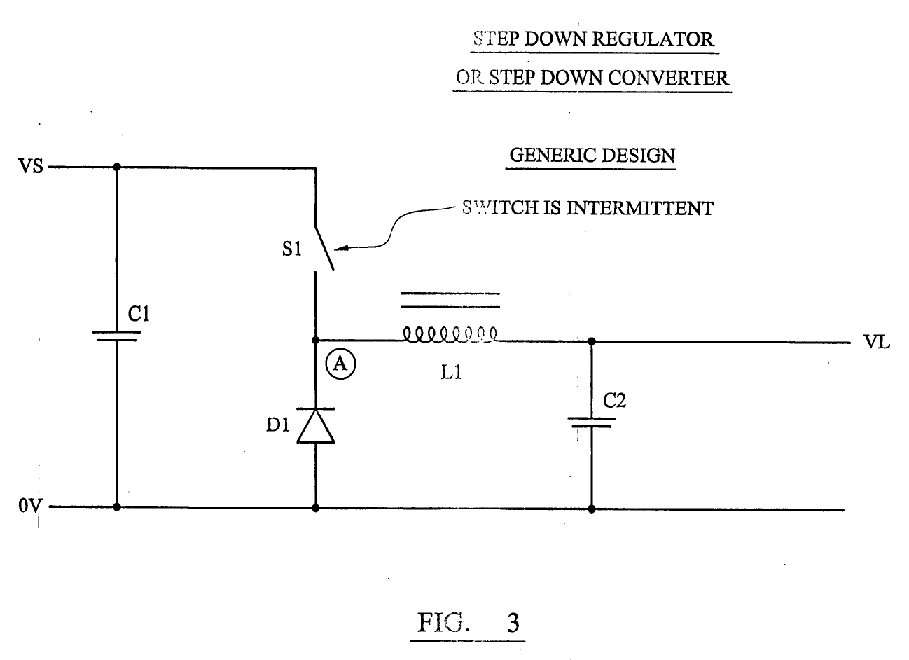

FIG. 3 is a circuit diagram of a step down convertor;

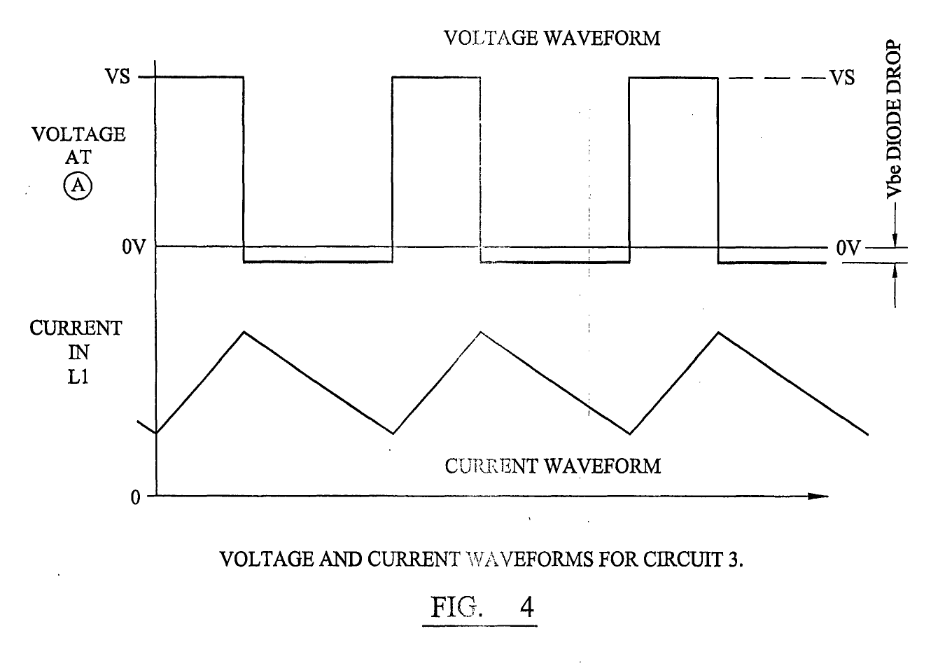

FIG. 4 illustrates voltage and current waveforms for the circuit of FIG. 3;

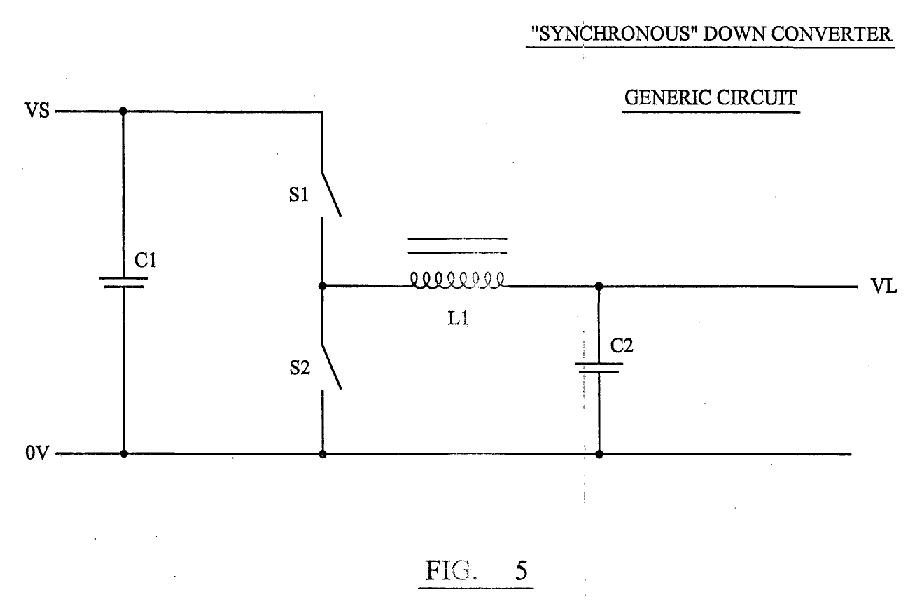

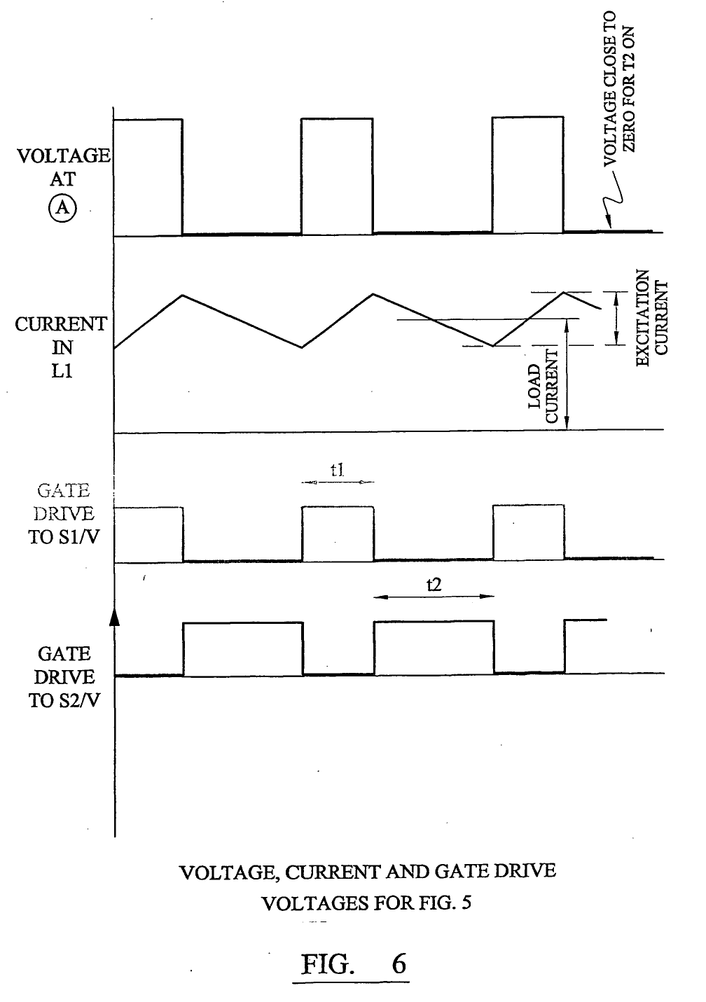

FIG. 5 is a circuit diagram of a synchronous down convertor;

FIG. 6 illustrates voltage and current waveforms and switch drive signals for the circuit of FIG. 5, including Gate drive signals that are applicable if switches S1 and S2 are implemented as MOSFETS, and which may otherwise be taken to indicate when a switch is signalled to be ON, and when OFF;

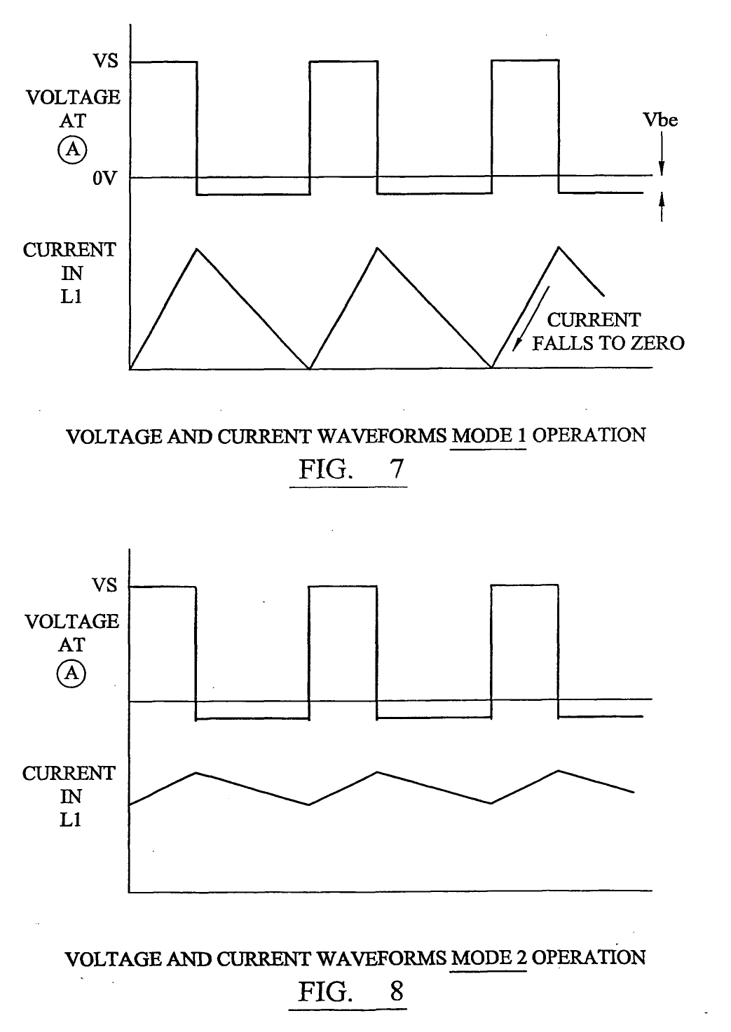

FIG. 7 illustrates voltage and current waveforms in a first mode of operation of the circuits of FIGS. 3 and 5;

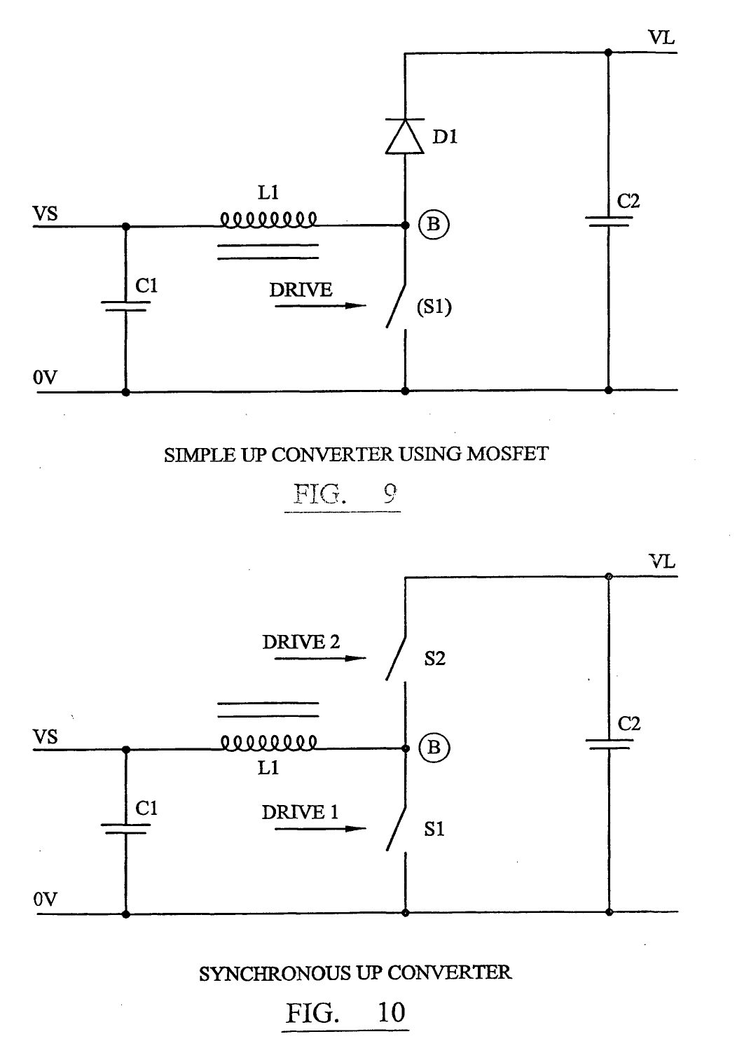

FIG. 8 illustrates voltage and current waveforms in a second mode of operation of the circuits of FIGS. 3 and 5; (note that in FIGS. 7 and 8, for application to FIG. 5 operation, the voltage drop V_{be} is absent);

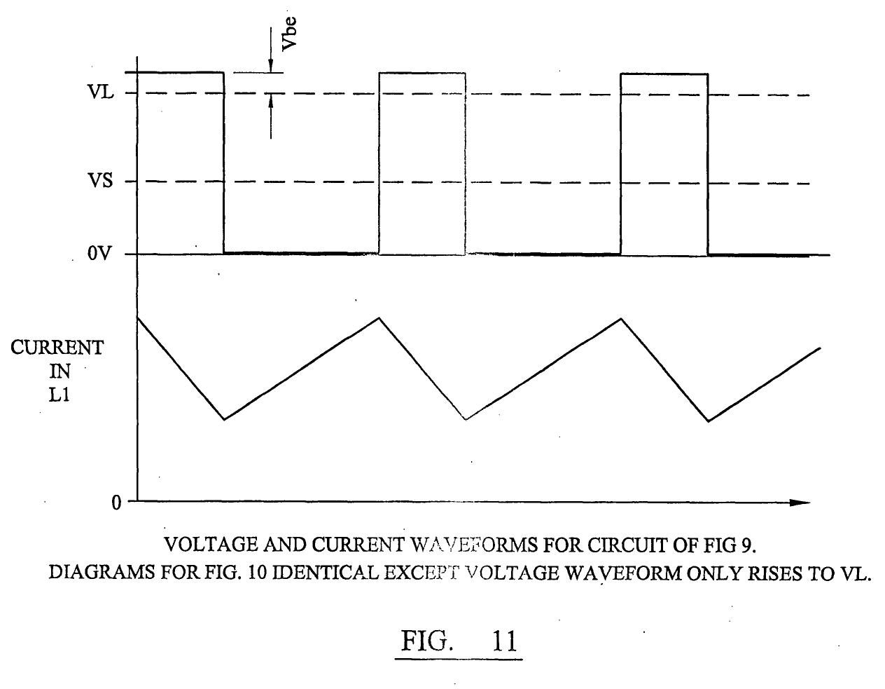

FIG. 9 is a circuit diagram of a step-up convertor;

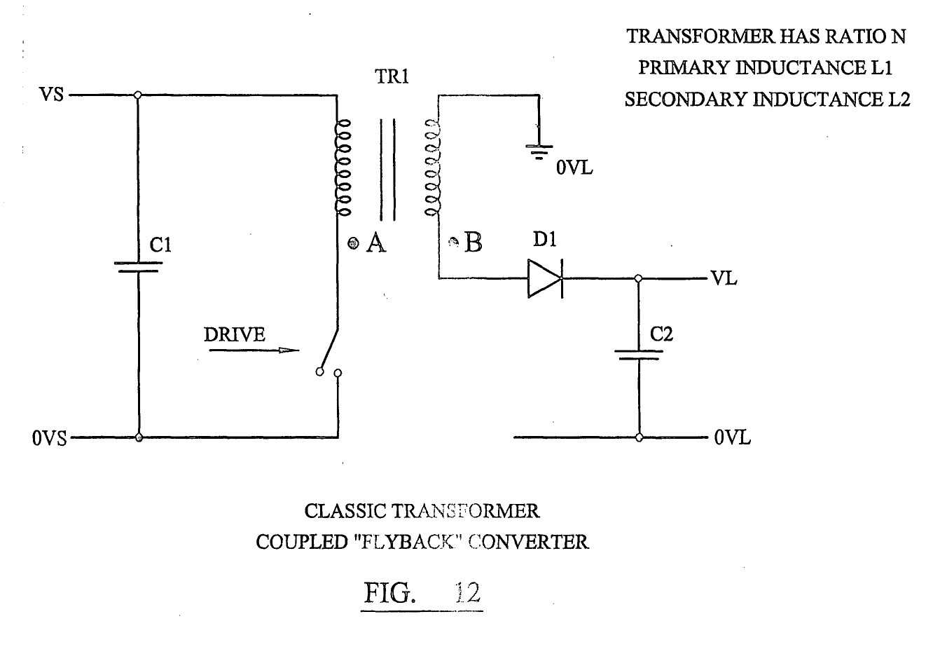

FIG. 10 is a circuit diagram of a synchronous step-up convertor;

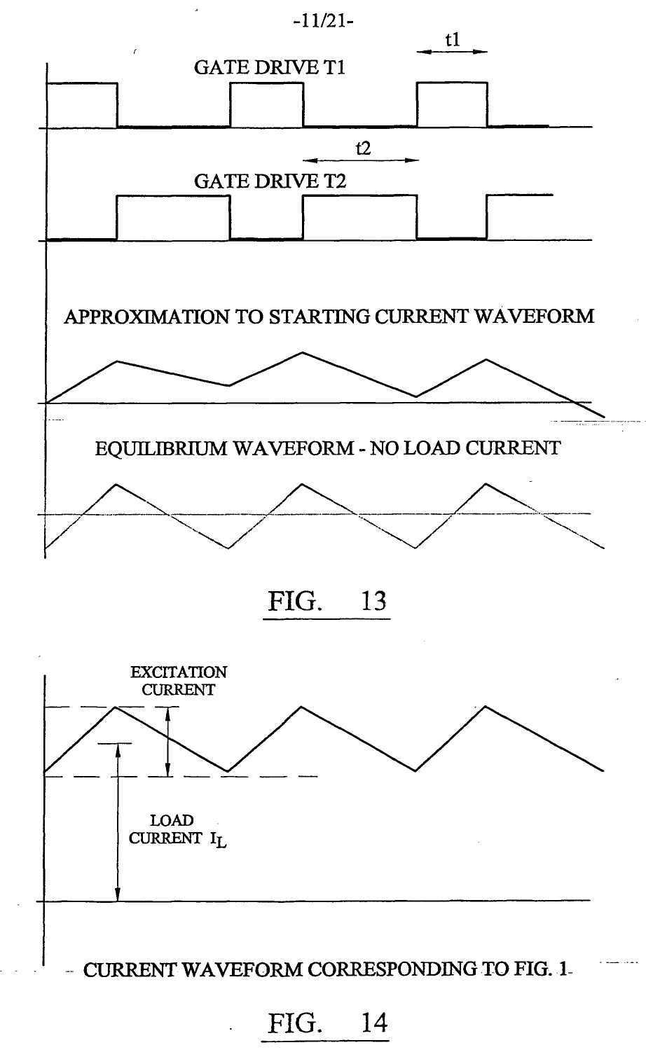

FIG. 11 illustrates voltage and current waveforms for the circuit of FIG. 9;

FIG. 12 is a circuit diagram of a transformer-coupled flyback converter;

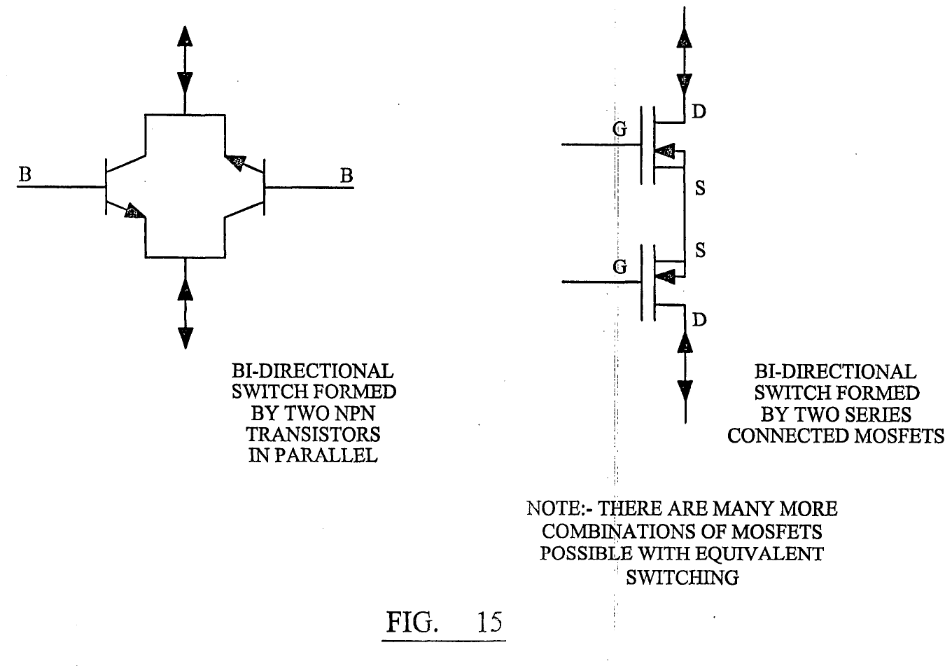

FIG. 13 illustrates gate drive voltages and current waveforms for the circuit of FIG. 1;

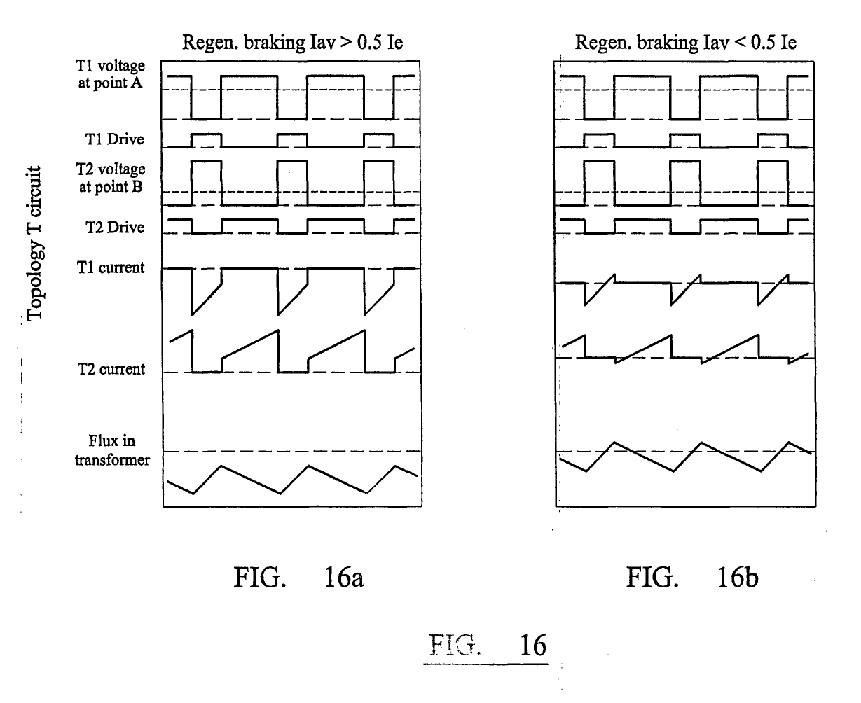

FIG. 14 illustrates the current waveform for the circuit of FIG. 1 when supplying a load;

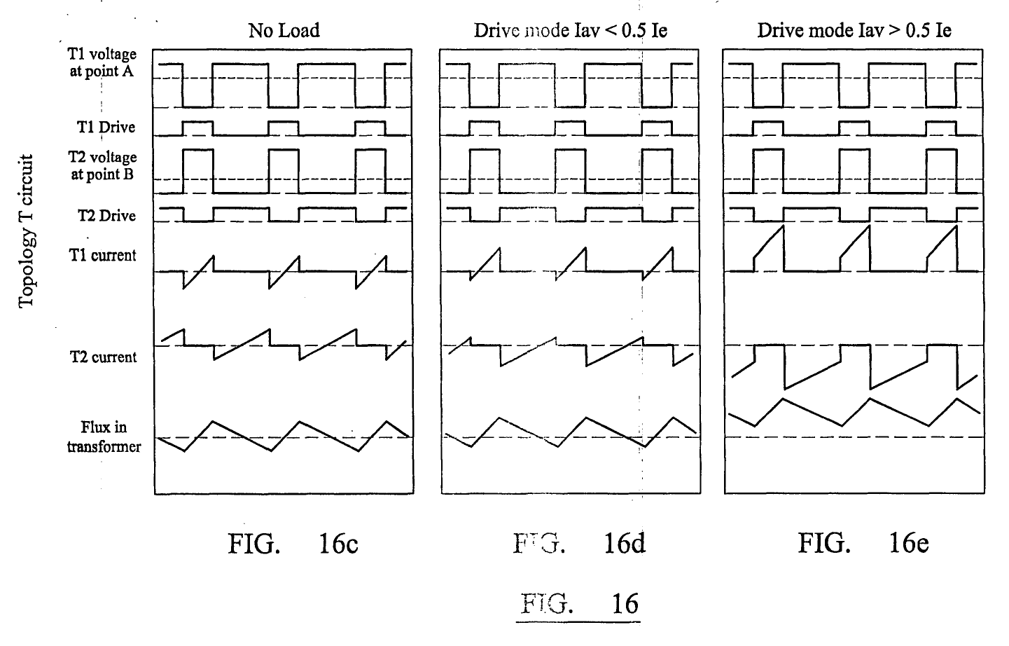

FIG. 15 illustrates two embodiments of bi-directional switches that could be used in place of switches S1 and S2 in the synchronous designs discussed herein;

FIG. 16, parts a to e, illustrates transistor drive voltages, transistor currents, transformer voltages and fluxes, for the circuit of FIG. 1 under various modes of driving an electric vehicle and performing regenerative braking;

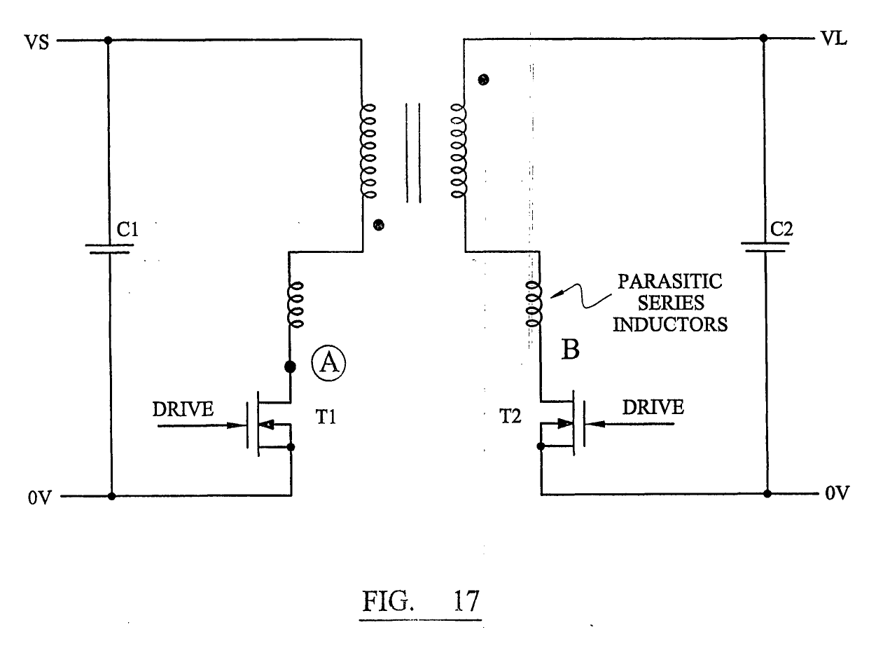

FIG. 17 is a circuit diagram of the circuit of FIG. 1, including illustration of parasitic series inductors modelling incomplete transformer flux linkage;

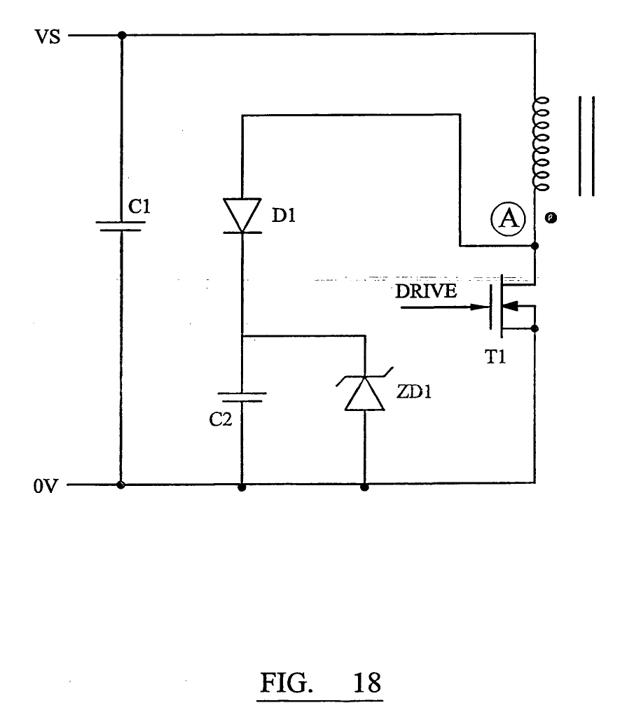

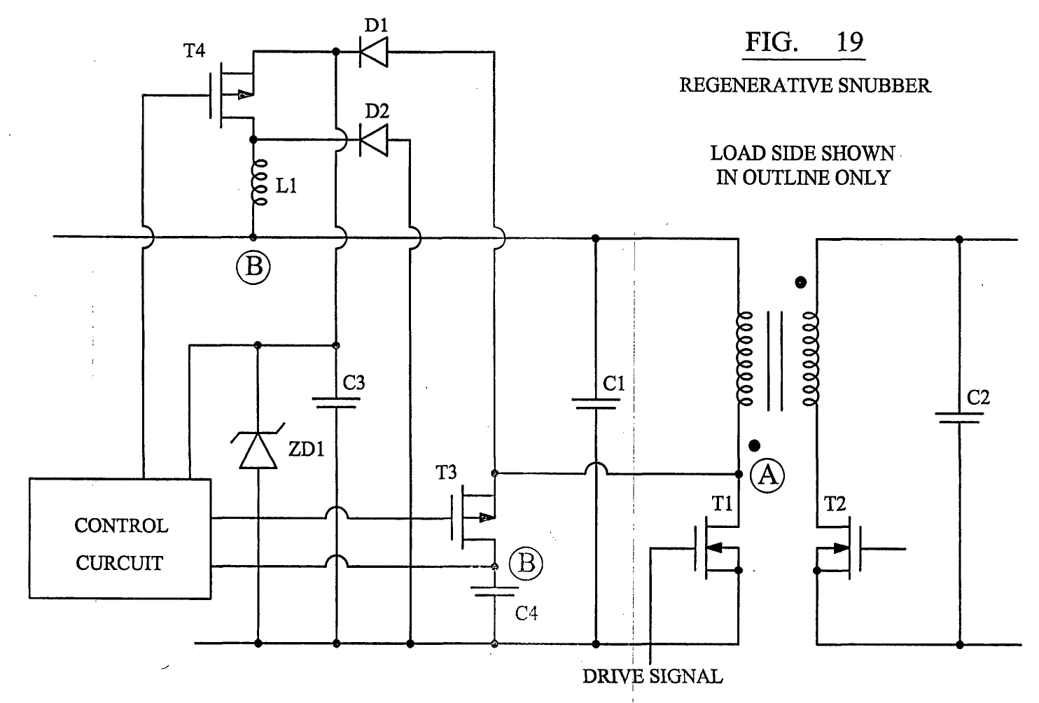

FIG. 18 is a circuit diagram of a snubbing circuit (half of circuit of FIG. 1 shown);

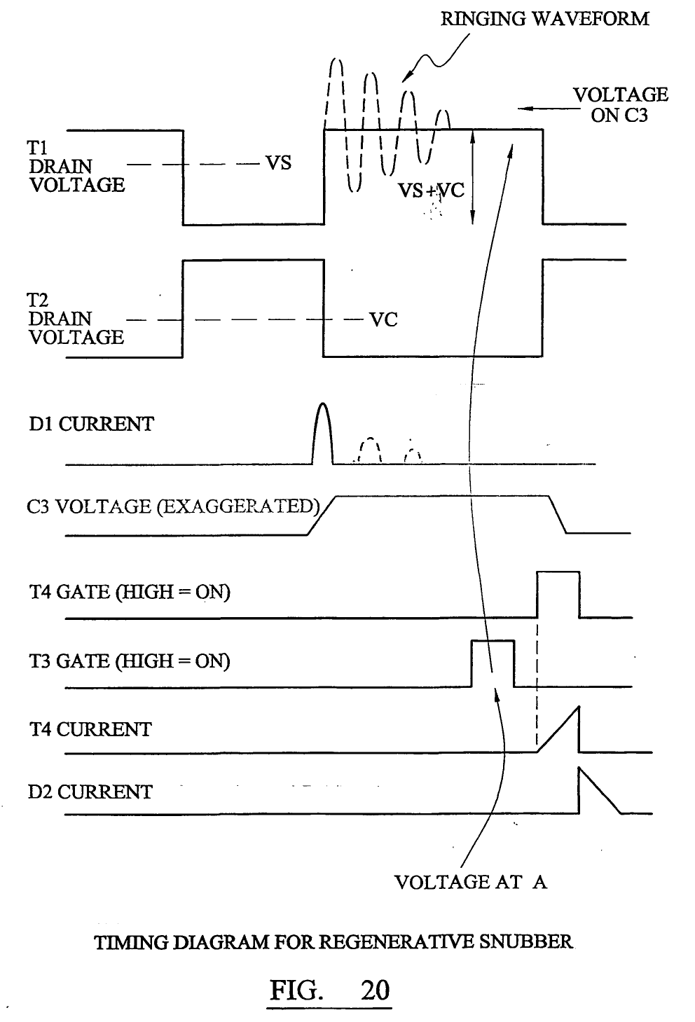

FIG. 19 is a circuit diagram of a first regenerative snubber embodying the invention;

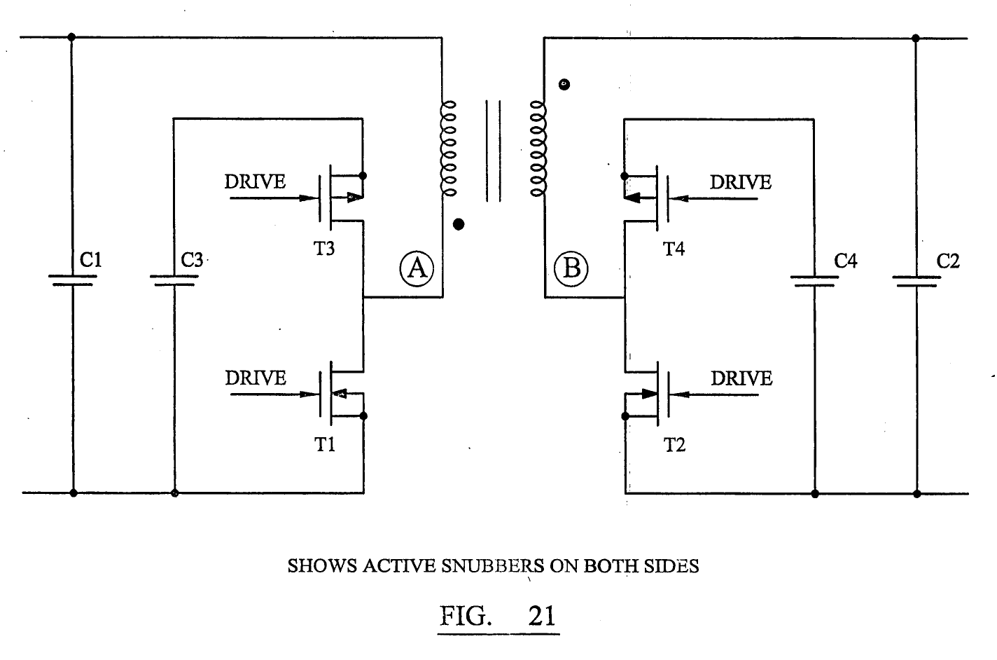

FIG. 20 is the timing diagram of FIG. 19;

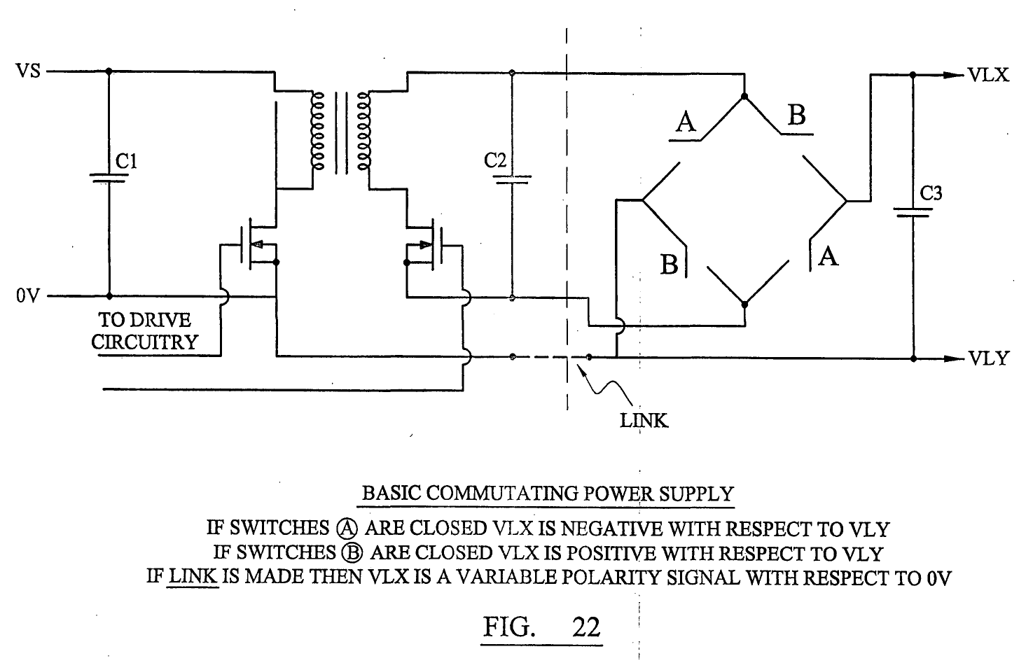

FIG. 21 is a circuit diagram of a second regenerative snubber embodying the invention;

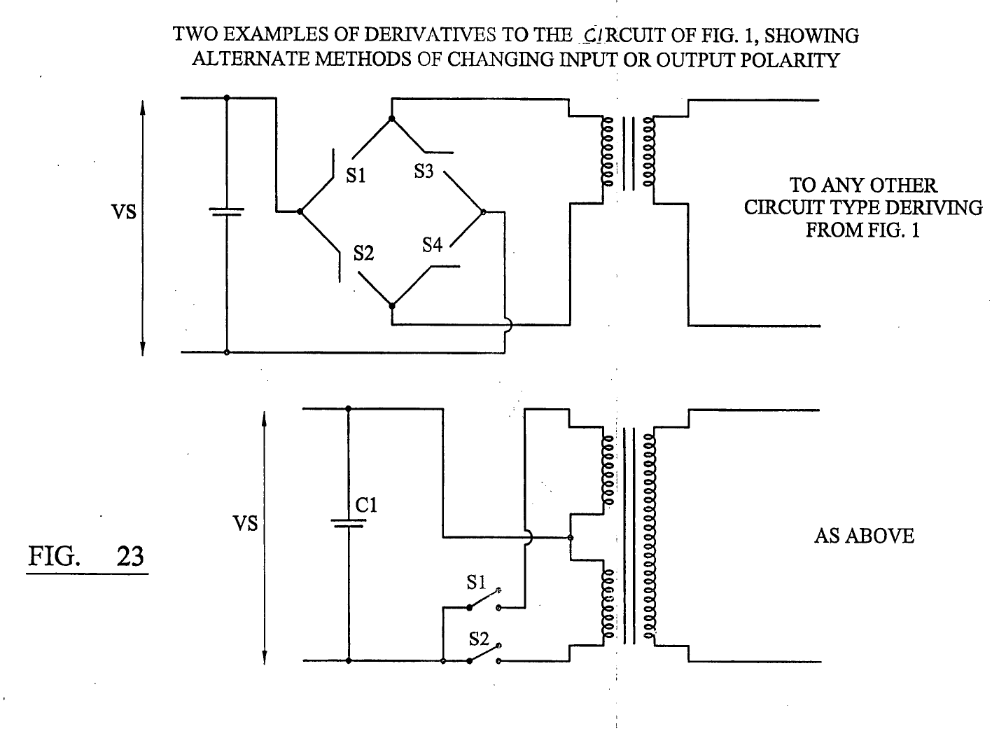

FIG. 22 shows the circuit of FIG. 1 with a commutating output bridge to allow production of outputs of either polarity; and

FIG. 23 shows two derivatives of the circuit of FIG. 1 illustrating alternate ways of changing the polarity of input or outputs.

FIGS. 1 and 2 illustrate circuit topologies embodying the first and second aspects of the invention.

The operation of the circuits of these embodiments can be described with reference to the following review of simpler switched mode topologies. A small number of ‘operating characteristics’ are to some degree common across the topologies, but characterise each generic circuit and generally lead to more than one mode of operation and control for a single topology. On top of that there are various ‘device characteristics’ for the switching elements that add further variants in practical circuits.

This review therefore seeks to categorise ‘Switched Mode’ circuits at three levels;

1. The topology;

2. The Operating Characteristics;

3. Circuit examples using particular classes of component that have particular properties.

The drawings have a sense of a positive DC supply. For all these circuits there will be an equivalent negative supply version that can be derived by reversing symbolism, and if necessary substituting a semi-conductor of the opposite sort (eg N channel MOSFET for P channel, NPN bipolar transistor for PNP) or reversing the direction of a diode.

### Simple Step-Down Converter

Probably the simplest SM design is the simple ‘Down Converter (or Step-down Converter) illustrated in FIG. 3, which takes a higher voltage DC supply and produces a lower voltage supply to an application.

Circuit operation is simple. Switch S is turned ON and OFF intermittently. Since the purpose is to reduce voltage, V_{S} (the supply voltage) is always greater than V_{L} (the voltage applied to a load). Thus, when switch S1 is closed, the action is to raise the voltage at A to that of the supply, and thus the current in the inductor starts to rise according to expression 1 below where dI/dt is the rate of rise of current.

dI/dt=(V_{S}−V_{L})/L exp 1

It is assumed that the two capacitors C1 and C2 are sufficiently large that voltage changes due to fluctuations in current over a cycle are insignificant. (In real circuits this is approximated; there will be voltage fluctuations but they do not affect the fundamentals of operation).

When switch S1 is opened current can no longer flow that way. However, the current through an inductance cannot change instantaneously: instead changes of current lead to changes in voltage. In fact S1 does not open instantaneously, but by a transition in which its resistance changes very rapidly, and thus the current into the inductance starts to change. This leads to a very rapid change in voltage at A, which drops until it is sufficiently below the 0V rail (by a diode forward voltage drop, commonly written V_{be}) for D1 to conduct. As soon as this point is reached the current through L1 continues, now flowing through D1.

In this state, with S1 OFF, the voltage sense across L1 is reversed, and current in L1 starts to decrease according to expression 2;

dI/dt=−(V_{L}+V_{be})/L exp 2

The current and voltage waveforms are shown in FIG. 4.

A variant of this circuit is shown in FIG. 5. This replaces the diode D1 with a lower switch S2. This adds an important property; it is now possible for current to flow in reverse through the inductor if S2 is turned ON.

The ‘Operating Characteristics’ of each circuit can now be described. FIG. 6 gives the generic operating waveforms for this class of circuit. However for the circuit of FIG. 3 the presence of the diode ensures that current through L1 can only flow from supply to load. There are two distinct modes of operation under this constraint, with a sliding scale of intermediate classes in between.

### Mode 1. Current Falls to Zero Each Cycle

This is shown in the waveforms of FIG. 7. When S1 is switched ON current is allowed to flow and increase, generally to the point at which the inductor is close to magnetic saturation. It is then switched OFF and conduction through D1 continues until current falls to zero. S1 may then be switched ON immediately, or left OFF for a while, depending on the load and control mechanism.

This is a common operating mode. The advantages are that it allows the use of the minimum sized inductor, since all of the stored magnetic energy is transferred each cycle. Disadvantages are that C2 has to be large to smooth out the large current pulses, and output voltage noise is generally high. Magnetic losses will also be higher due to the high flux changes per cycle.

### Mode 2. Current is Maintained at all Times (Now Called “Current Mode” in Commercial Literature)

This is shown in the waveform drawing FIG. 8. When S1 is ON current rises, but it will be switched OFF at some time determined by the control circuit. When S1 is switched OFF current flows through D1 but falls with time until S1 is then switched back ON. In this mode of operation a larger inductor must be used, but the exciting flux changes that cause the forward flow of current can be kept small. The current then varies very much less than in mode 1, and consequently the requirements on C2 or the output voltage noise are reduced. This circuit produces a lower noise output and lower magnetic losses.

Note here that in modes 1 and 2 the presence of the diode means that the output voltage is not always directly controlled. The control circuit can determine the switching time of S1, and this controls the current into L1. However this circuit has to have a load to be stable, and the relationship between switching time and output voltage depends on the load characteristic. With a zero load any repetitive switching on of S1 would cause C2 to charge to the supply voltage V_{S}.

The properties of the circuit shown in FIG. 5 can now be described. Firstly it must be stated that there is a general condition assumed that one of the switches S1 or S2 is always switched ON, but that they are never ON together, termed “synchronous switching”. Thus the general operating condition is that there is a drive waveform going with opposite senses to both switches, but with a variable ‘mark-to-space’ ratio.

It would of course be possible to drive this circuit so that at some time neither switch was turned ON. In a practical case it would then be necessary to add back D1, in parallel to S2, as protection against high voltage transients. In this case operation would become a hybrid between mode 1 and mode 2.

In FIG. 5 the rate of rise and fall of current is simply determined by the relative values of supply and load voltage. However it is now possible to make a voltage control equation that directly relates the supply and load voltages to the ON times of the two switches. This applies when the average of the sawtooth current waveform is equal to the load current, ie when V_{L} is constant. This equation is derived by matching the slopes and times of the current waveforms (t1 is ON time of S1 and t2 is ON time of S2).

Average current is constant, so change in current upwards in t1 equals change in current down in t2, as follows.

dI₁/dt·t1=−dI₂/dt·t2

((V_{S}−V_{L})/L1)·t1=(V_{L}/L1)·t2

V_{S}·t1=V_{L}·(t2+t1)

V_{L}=V_{S}·t1/(t2+t1) exp 3

ie, V_{L} is directly determined by the mark to space ratio of the controller.

It can be seen that this equation actually applies to the diode circuit of FIG. 3 when it is operating in mode 2 above (if the diode drop V_{be} is ignored).

### Mode 3

A third mode, mode 3, applies only to the synchronous circuit of FIG. 5. When the average current drops it can now go negative, and the voltage relationship is maintained. In the case of zero load current the equation still holds, and equal quantities of total charge (current times time) are repetitively exchanged through the inductor, maintaining the voltage ratio.

A useful distinction is to term the fluctuation in current (peak to trough for each waveform) as the ‘excitation current’, and the average current as the ‘load current’, as illustrated in FIG. 6.

The Operating Characteristics can now be summarised.

### Operating Characteristic 1a

If the lower element is a Diode D1 as in FIG. 3, then in general the load voltage cannot be controlled at low currents simply by the mark-to-space ratio of the switching control signals. This will occur when the load current is less than half the excitation current, since that is the point at which the current flow through the diode needs to reverse to maintain equilibrium.

There is therefore unavoidable power loss. All the other circuit elements can be chosen to be as close to zero power loss as possible, but the voltage drop across the diode is intrinsic. At high voltages this can become negligible, but at low voltages it is increasingly important.

### Operating Characteristic 1b

If the lower element is an active switch that allows conduction in either direction, then the relationship of voltage ratio to switching times is maintained at all currents (Exp 3). The power loss associated with the diode is also removed.

True synchronous operation of the circuit of FIG. 5 has some other important advantages which carry over into the designs embodying the present invention;

### Operating Characteristic 2

The device is a true ‘voltage source’ (over several cycles). If the load is reactive, and tries to move the output voltage in either direction away from the voltage set by Exp 3, then the system, to a first approximation, is self correcting (without altering the mark-to-space ratio of the drive). Currents will alter, flowing either into or out of the load as necessary to keep Exp 3 true.

### Operating Characteristic 3

The device is reversible, subject only to the condition V_{S}>V_{L}, current can flow from load back to supply, under the same voltage control expression Exp 3. If for instance the supply was a rechargeable battery, and the load a motor dynamo, then this circuit would provide complete control.

Since it is reversible, it will be noticed that it is in fact identical to the synchronous Up converter described below

### Operating Characteristic 4

The drive rule must be that S1 and S2 are not on simultaneously (otherwise there would simply be a short across the supply). In practice this means that there must be some small delay between one switch turning OFF and the other turning ON. In some circuits such delays can produce problems of their own, but here there is a simple condition which is described later (in the context of FIG. 1) that is in fact advantageous.

### The Step-Up Converter

The simple generic circuit is FIG. 9. The synchronous version is shown in FIG. 10. As noted above this is identical to the Synchronous Down converter circuit, simply drawn right to left.

Operation for the diode version is as follows, and can be seen in the waveforms of FIG. 11. Switch S1 turns ON and the voltage at B is taken to 0V, thus the voltage across the inductor is V_{S} and the current in the coil increases according to expression 4:

dI/dt=V_{S}/L exp4

At some time switch S1 is turned OFF, and the voltage at B rises until it is sufficient to drive current through D1 into C2 (ie V_{L}+V_{be}). The voltage across L is now V_{L}−V_{S} (neglecting the diode drop V_{be}) and current through the inductor falls according to expression

dI/dt=−(V_{L}−V_{S})/L exp 5

The voltage and current switching waveforms are shown in FIG. 11. As with the Down Converter the system where the load current is more than half the excitation current is governed by the mark to space ratio of the ON and OFF times according to

t1·dI/dt1=−t2·dI/dt2

t1·V_{S}=−t2·(V_{L}−V_{S})

V_{L}=((t1+t2)/t2)·V_{S} exp6

As with the Down Converter this relationship breaks down with loads less than half the excitation current.

Addition of S2 instead of D1 has precisely the same effect as with the Down converter, and it can be seen in the two fully synchronous devices when are exactly equivalent.

### ‘Flyback’ Converter

A transformer coupled ‘Flyback’ circuit is shown in FIG. 12. This is the conventional method of making high voltages from a low voltage supply. In this conventional application the purpose of the transformer is to provide a turns ratio which will boost the switching voltage at the ‘secondary’ side of the transformer. Since diodes are available with very high reverse breakdown voltages it is thus possible to separate the halves of the circuit of FIG. 12, using a low voltage transistor on the primary side.

Operation is essentially the same as for the circuit of FIG. 9. When S1 turns ON point A is pulled to 0V. Since the sense of the transformer windings is the same (as shown by the black dots), this will cause point B to go low with respect to 0V. This will bias diode D1 off, so no current can flow in this winding, and therefore it cannot contribute to the flux of the transformer. Current in the transformer will therefore rise according to the primary inductance L1 of the transformer, ie

dI₁/dt=V_{S}/L1 exp7

However when S1 switches OFF, the voltage at A will rise very rapidly as will the voltage at B. There is nothing to stop the voltage rise at A, but at some point the voltage at B will rise above V_{L}, and D1 will start to conduct. The voltage at B will now stop rising since the flux in the core is now causing conduction in the secondary. If the turns ratio is N, then the voltage at A will rise to (V_{S}+VL)/N (again neglecting the diode forward voltage). The magnetic flux in the core will now start to fall according to the expression

dI₂/dt=−V_{L}/L2 exp8

(However by simple transformer theory the secondary inductance is N²×L1).

All the conditions described for FIG. 5 apply, once it is understood that the current now flows alternately in the two windings, and that the turns ratio is now a factor.

### Circuit Topology T

The work for which this invention was originally made needed a high voltage generator circuit that could both charge and discharge a load capacitor. The ‘flyback’ circuit of FIG. 12 is of no use, since it can only charge the load, to get the voltage to go down it is necessary to have bleed resistors.

The intention was therefore to take the circuit of FIG. 12, making use of the winding ratio to get the required high voltages, but to add in an active(high voltage) switch instead of D1, this getting the advantages of the synchronous circuit of FIG. 9. As drawn in FIG. 12 it is not easy to understand, as the diode is at the high voltage. However it was discovered that the circuit of FIG. 12 could be altered by re-arrangement, as shown in FIG. 1.

Now FIG. 1 has an anti-symmetrical transformer, but in all other respects it is symmetrical. The specific design at the time of invention required a high winding ratio, but this circuit is advantageous at all sorts of winding ratios, including 1:1. This completely symmetrical case will be described first as this circuit has some remarkable properties.

The rule for driving the gates of the two switches (implemented as MOSFETs T1, T2 in FIG. 1 and as described below, is that only one is turned ON at a time, but as soon as one turns OFF (after a short delay) the other turns ON (see note below on delays), i.e. they are driven by signals of variable mark-to-space ratio and alternate phase. Also, for consistency with earlier drawings, this design is considered in terms of a supply side and a load side; as it will be seen this distinction is now appropriate only if it makes sense in terms of the application, this distinction is not a part of the circuit itself.

To understand the operation of this circuit, first consider the case where there is no load, and there has been no previous operation of the circuit. T1 turns ON and current starts to flow in the primary side. T1 has brought point A low, and since the transformer sense is reversed this will swing point B high. With point B going high and T2 turned OFF, no current can flow in the secondary, and so the build up of current in the primary winding is controlled solely by the primary inductance L1. Current thus rises according to;

dI₁/dt=V_{S}/L1 exp9

At some point T1 is switched OFF. Due to the inductance L1, the voltage at A will now rise very rapidly and that at B will fall rapidly; these rapid voltage changes will stop as soon as point B has gone sufficiently negative to turn on the intrinsic diode of T2. At this point transistor T2 will be turned on by the control circuit.

During the ON period of T1, current was flowing in the primary winding in the positive to negative sense, through T1, and this established a magnetic flux in the core that cannot instantaneously change. Current linked to this flux cannot now flow in the primary because T1 is turned off, so the flux now links to the secondary where current is flowing. Because the senses of the primary and secondary are reversed this current will now flow in the opposite direction in the secondary circuit, ie from ground into C2, increasing the charge of C2 and tending (in the limit only since C2 is considered large) to increase its voltage.

However the voltage across the secondary from V_{L} is positive with respect to 0V and is in the opposite sense to the current flow, and the current in the secondary will tend to drop according to

dI₂/dt−V_{L}/L2 exp10

Depending therefore on the mark to space ratio of the drive it can be seen that the voltage on C2 can be made to rise, with a current waveform approximating to FIG. 13.

It is more useful to consider the equilibrium state, where there is no net increase or decrease of flux in the core. For an arbitrary mark to space ratio t1:t2 and steady supply and load side voltages V_{S} and V_{L} then

(dI₁/dt)·t1=(dI₂/dt)·t2 exp11

(Note sign reversal of earlier expressions now removed since winding sense is reversed).

So, in steps very similar to all the other synchronous cases

(V_{S}/L1)·t1=(V_{L}/L₂)·t2 exp12

However this is the case for an equal turns ratio, so L1=L2 so

V_{S}·t1=V_{L}·t2 or V_{L}/V_{S}=t1/t2 exp13

Thus for the equilibrium case the time ratio and voltage ratio are directly related. Note however the very important feature that the voltage terms are now fully separate (in the fully synchronous down and up converters one voltage was always in series with the others, so that the output voltage was always either lower or higher than the supply). Since they are separate the output voltage can now move smoothly from below the supply voltage to above it, with the 50:50 ratio producing an output voltage equal to the input voltage.

Now consider the case of a load on the right hand (load) side. This will take an essentially steady current I_{L} (approximation of C_{L} large) simply given by Ohm's law. In the steady state this current can only come from the secondary circuit, but since current can only flow in this for a time t2, the current that must exist in the secondary I₂ must be larger by the time ratio;

I₂=I_{L}·(t1+t2)/t2 exp14

However when T1 is ON and T2 OFF, this load current links to the primary winding. Since it flows for a time t1, the average current coming in from the supply, I_{S} must be

I_{S}=(t1/(t1+t2))·I2(t1/t2)·I_{L} exp15

Thus it can be seen that this circuit has current and voltage ratios that are both governed by the switching mark to space ratio, and in such a way that the condition that the power in and power out are (as is clearly necessary) equal. To recap

Voltage ratio V_{L}/V_{S}=t1/t2

Load current ratio I_{L}/I_{S}=t2/t1

Power condition Power out=V_{L}·I_{L}=V_{S}·(t1/t2)·I_{S}·(t2/t1)=V_{S}·I_{S}=Power in

Rate of change of current dI₁/dt=V_{S}/L

dI₂/dt=V_{L}/L exp16

Note that in analogy with the other fully synchronous circuits there is a load current and an excitation current, however in view of the reversible nature of this device the expression ‘load current’ must now be taken to mean the steady current that flows in one direction or the other. The total current in the windings it the sum of the load and excitation currents.

The features of this circuit are;

Isolation between input and output can be provided if the transformer is wound to provide effective isolation.

Voltage ratio between sides goes from below to above supply voltage, (or vice versa).

Each side is equivalent. The system is symmetrical and reversible. It can be used both to charge and discharge capacitative loads, or to run and to brake a motor.

In motor control applications the system is naturally regenerative, power will come from supply to motor load to accelerate or run the motor, but back from motor to supply when the controller is used to brake the motor. Motors can be used where the voltage rating and supply are not the same.

Each side is a pure voltage source with the time ratio setting the voltage ratio, and any departures from that ratio causing extra current to flow in such a sense as to attempt to correct the voltage ratio.

Since each side is a voltage source and the transformer can provide isolation, an output can be connected to a switching bridge so that it can produce voltages of either polarity. This is the basis of low and medium frequency Power Amplifier applications. This is shown in FIG. 22.

For completeness a note is needed on the system where a winding ratio is used on the transformers. Simple modification to the equations above yield the following results where N is the turns ratio (assuming secondary is N times primary turns)

Voltage ratio V_{L}=V_{S}·N·(t1/t2)

Current ratio I_{L}=I_{S}·t2/(t1·N)

### Switches

Here it is necessary to discuss the nature of the switches in the circuits described above when realised with semiconductor devices, and this leads to discussions of derivative designs that are included within the scope of this invention.

The switch S1 in the step down convertor of FIG. 3 could be replaced by any form of semiconductor device that is capable of switching ON and OFF. Switches have been drawn as ‘ideal switches’ to show that something that emulated the performance of a simple contact closure electronically would, practicalities admitting, perform the function. However ‘ideal switches’ can block voltage in both directions, and switch current in both directions. Practical semiconductors tend to have limitations, but in fact the simple up and down convertors with subsidiary diodes (as in FIGS. 3 and 9) only need switches with more limited properties. These designs have been implemented for many years with bipolar transistors, which conventionally can only block voltage in one direction, and only pass current in one direction. MOSFETs have later been used in these circuits, as have IGBTs (insulated gate bipolar transistors), but using only using the properties that bipolar transistors exhibit. For Bipolars both PNP and NPN transistors can be used. The down convertor is neatest with a PNP, and the up-convertor naturally works with NPN, but there is an advantage at higher powers to use NPN in both due to the generally advantageous properties of NPN transistors over PNP. Parallel considerations exist for MOSFETS in N and P channel versions.

However an active switching device for S2 in the synchronous down converter of FIG. 5 is subject to importantly different conditions. For the voltage relationship (Exp 3) to be maintained down to zero current the switch when closed must be able to allow current flow in both directions. Note however that in these designs the device still only needs to block voltage in one direction (when switched off) and so is still not exhibiting or requiring all the properties of a perfect switch.

Power MOSFETs have an intrinsic diode as part of the substrate structure. Such a MOSFET may be crudely modelled as a switch in parallel with the intrinsic diode. This diode is useful in many switching applications since it turns ON if the voltage (for an N-channel device) goes below the Source voltage and thus acts in a protective manner. It is therefore normal for the MOSFET manufacturers to design the transistor so that the diode and transistor channel have similar voltage and current ratings.

It is critical to appreciate, however, that current flows equally well in either direction when a MOSFET is turned ON, and in this state any reverse current will go through the transistor channel rather than the diode since there is no forward voltage drop (only a resistance) and the “IR” (Current×Resistance from Ohm's law) voltage generated is normally less than the forward turn-on voltage of the diode.

There is thus a distinguishing and advantageous mode of operation of the circuit of FIG. 5, if implemented with MOSFETs T1 and T2 in place of switches S1 and S2 respectively, making use of the availability of the reverse current mode of the MOSFETs.

As soon as MOSFET T1 switches OFF, then MOSFET T2 switches ON (noting the practical delays described below). Presuming that the controller is functioning correctly, current at the time of this transition will be flowing into the inductor. Thus as T2 switches on current is coming out of the 0V rail and into the inductor L1. It is thus flowing from Source to Drain, the opposite of the normal current sense for an N channel MOSFET. As explained above, if the load current is more than half the excitation current, the current flow through T2 will remain reversed until it turns off. If it is less than half then at some time in its ON period the current direction will reverse, and so for the latter part of the ON time current will be in the normal sense for an N channel MOSFET.

In this mode the MOSFET is ON throughout its proper period and the power losses are “IR” losses through the channel; there is no unavoidable voltage drop due to the diode operating.

This mode is distinct from operation of the circuit using a Bipolar transistor and an anti-parallel diode in the same situation. Due to the properties of Bipolars all ‘reverse’ current would flow through the diode and, depending on the transistor properties, it might be necessary to alter the drive to the transistor, dependent on instantaneous current direction, to protect the transistor.

These comments apply also to the upper switch S2 of the synchronous up converter of FIG. 10, as do both switches in the circuit embodying the invention of FIG. 1 (topology T).

According to a preferred feature of the invention, the switches in the circuit of topology T are implemented using N-channel or P-channel MOSFETs, or other bi-directional switches, to permit true synchronous operation with reduced power losses (because no conduction by diodes is required) regardless of whether the excitation current is greater or less than double the mean current, and in cases where the excitation current changes between these conditions during operation of the circuit. It should be noted that operating conditions 2 to 4 described above can only truly be achieved under these circumstances using bi-directional switches.

MOSFET transistors exhibit particularly advantageous properties In this application. Although, as noted above, they do not exhibit all the properties of an ideal switch in that they cannot block voltages in both directions, this is not needed in the first embodiment of the invention as shown in FIG. 1. However, as noted earlier, an important aspect of this invention is the use of transformer coupling and active synchronous switching described in relation to FIG. 1, combined with bi-directional switches with no intrinsic forward diode drops. There is therefore a large class of circuits that can use this basic feature of the invention in derivative designs, and there are alternative semiconductor switches with bi-directional properties, which produce many combinations which are nonetheless part of this invention.

FIG. 15 shows two examples of true bi-directional switches that can be constructed from conventional discrete components.

The first shows the true properties of Bipolar transistors. Conventionally these can only block voltages in one direction, but they do have a limited ability to block the opposite polarity once it is realised that when the polarity of voltage across the Emitter and Collector is the opposite of that which is conventional, then effectively these two terminals swap function, and thus any considerations concerning bias to the Base terminal must then be considered in relation to the ‘acting’ Emitter connection, not the labelled Emitter terminal. In this reverse mode a Bipolar transistor operates as a very poor transistor, with very low current gain. It can however be turned off by connecting its base to the ‘acting emitter’ (manufacturer's, or labelled, collector terminal) and in the OFF state has an ability to block (low) applied voltages (perhaps 10 or 20 volts).

Thus in the example of the two back to back NPN Bipolar transistors in FIG. 15, the transistor that is biased in its conventional sense acts normally, and is essentially wired in parallel to a very low gain transistor of the same sort. In many circumstances it will be sufficient to connect the two Base terminals together, but this depends on device characteristics. In other circumstances it may be necessary to have more sophisticated Base drive signals.

Such a device would have utility in all of the examples cited above (e.g. the embodiment of FIG. 1, and the synchronous up and down converters) at low voltages, where the low ON saturation voltages of Bipolar transistors may prove advantageous as opposed to the “IR” voltage drop of a MOSFET. There is significant need presently to develop power supplies for portable equipment having high efficiency at very low voltages (0.5-4 volts DC) and this double NPN device may advantageously be used in such applications.

However this device adds the property of blocking voltages in both directions. It therefore offers the possibility of use in derivatives of the first embodiment of this invention.

Consider the circuit of FIG. 1 where the voltage V_{S} is derived from an AC (alternating current) supply. With a true bi-directional switch in the position of T1, it can be seen from symmetry that the circuit of FIG. 1 can work with either polarity of input, however the output is constrained to be of the same polarity as the input. FIG. 22 however shows a circuit with the addition of a commutating bridge. It can be seen that such a circuit commutating as the polarity of the input changes can create a constant DC voltage directly from an AC supply, with the mark to space ratio changing to generate the varying relationship of input to output voltage. Note also that if the mark to space ratio is further adjusted to limit the current flow out of C1 to be proportional to the instantaneous value of input voltage V_{S}, then ‘power factor correction’ is achieved as the load imposed by the system is proportional to voltage, and thus looks like a resistive load. Note that in this configuration C1 is selected to be big on a cycle by cycle basis, but small in terms of the frequency of the AC supply, on the assumption that the switched mode switching frequency is several orders of magnitude higher than that of the supply.

As mentioned above, the dual bipolar transistor device using currently-available transistors only works at relatively low voltages, and would not work to advantage from mains AC supplies.

However the second device on FIG. 15, showing two MOSFETS in series, can work from a mains AC supply. The detail of the necessary gate drive signals will be different, however in application the considerations outlined above for the double Bipolar device apply.

Note that double devices for Bipolars and MOSFETs combine in three ways, NPN-NPN, PNP-PNP and PNP-NPN (for the latter, base connection considerations differ from the discussions above), with similar and additional combinations for MOSFETS. Any variant that can block both polarities can be configured to provide essentially identical function.

Note also that there is no advantage in use of the double MOSFET in the single polarity example shown above; this is where the parallel between Bipolars and MOSFETS breaks down.

Finally note that the bridge commutation circuit of FIG. 22 is not the only means by which the invention in the first embodiment can change output or input polarity. Two alternatives are shown in FIG. 23. In the first the commutating bridge is combined with the switching function (and here shown on the supply side). In the second two transformer windings are shown on the input. Such derivations can also be combined, with one or more windings on either side.

All of the variants of topology T advantageously operate as follows. The first phase of operation is when a switch attached to a transformer winding that is at that time on the supply side, turns ON. Current in that winding, and magnetic flux in the core, then rise. At some time this switch is turned OFF, and current begins to flow in a winding that is at that time a load side winding, and the switch associated with that winding turns ON. The polarity and winding sense are always such that in this phase the voltage on the load side opposes the sense of current flow, and charge is increased in the reservoir capacitor associated with the winding. The current in the winding, and flux in the core, then reduce. Thus, energy is transferred from supply side to load side via flux in the core. Only one side of the circuit conducts at any time, and generally (but not necessarily) the cycle of operation is to alternate supply and load side cycles. Multiple supply and load side circuits may alternatively be used. When switches are ON, current can flow in either direction through a winding, and the mark-to-space ratio between the switching times between any combination of load and supply side circuits determines their voltage ratios.

### Circuit Topology L

Thus the topology T circuit does appear to be potentially very useful, but work has been undertaken to see if another circuit with the same main properties could be devised with only a simple inductance, ie a variation of the synchronous Up or Down converters that would combine the two modes of operation, and be fully reversible and symmetrical (of course this necessarily means that the isolation property of Topology T cannot be realised).

FIG. 2 shows an Up and Down converter combined by sharing an inductor. This circuit does not truly work seamlessly, but moves from one mode to the other with a switch-over at the point where the supply and load voltages are the same. The table below shows the operation of the semiconductor switches, S1, S2, S3, S4 (T1, T2, T3 and T4); at any time two (a vertical pair T1 and T2 or T3 and T4) are switching synchronously and of the other vertical pair the top one is ON and the lower one OFF; they are simply used to set the mode. Of course this circuit is completely symmetrical and can be used reversibly: as with the synchronous circuits described above, current can flow in either direction depending only on load and supply conditions, with the drive signals setting the voltage ratio.

### Operating Table; for Topology L

RH (right hand in FIG. 2) voltage lower than LH (left hand) voltage:

T1 is ON; T2 is OFF;

T3 and T4 are actively switching.

Straight through, voltages equal:

T1 is ON; T2 is OFF;

T3 is ON; T4 is OFF.

RH voltage higher than LH voltage:

T1 and T2 are actively switching;

T3 is ON; T4 is OFF.

Comparing this circuit with that of topology T the following features are important;

There are twice as many transistors involved, and any current flowing has to pass through two transistor switches, so IR losses might seem to be higher. Against this the inductor has only one coil, so this can be thicker and IR losses here will be less. Also, at any time one of the two transistors that the current passes through is always turned permanently ON; there are therefore only the same number of transistors generating switching losses, which tend to be the more important mechanism.

On cost, the semiconductor cost is apparently doubled, but the coil cost is probably less.

However it can be seen that the maximum OFF state voltage that the MOSFETs ever have to withstand is either V_{S} or V_{H} (whereas in topology T it is V_{S}+V_{H} (plus any ringing). This factor is likely to bring the MOSFET cost down relatively, comparing like for like, as lower voltage MOSFETs will generally be cheaper.

The topology L circuit can be realised with N-Channel and/or P-Channel MOSFETs. For high powers the relative advantages of N-Channel devices will prevail and the circuit using these as shown in FIG. 2 will probably dominate. However the drive circuits for the upper pair, T1 and T3, are then more complex. For low and medium powers a design where the upper pair are P-MOSFETs and the lower pair N-MOSFETs is very convenient as the drive circuits for the P-channel devices are much simpler (for negative generating analogues of this circuits an N and P channel mix with the appropriate reversals is possible, as are both N and both P, but for the reasons given above a circuit using two N channels is normally preferable.

It will also be noted that the inductor of topology L provides certain advantages over the transformer of topology T, although it does not provide electrical isolation. In topology T, by comparison to topology L, only half the copper in the transformer coil (assuming for the sake of example a 1:1 turns ratio) will be in use at once. For a constant number of turns (compared to an inductor) the copper cross-sectional area will be half, and the winding resistance double, so copper losses (ie IR heating of the windings) will be at least double. There are other factors to do with the mark-to-space ratios for a given application, where it is hard to set up exact parallels, but most suggest that copper losses will be higher again due to these factors.

It is therefore expected that Topology L (the second embodiment) will dominate high power applications, particularly motor drives, whereas topology T (the first embodiment) will find applications where isolation is important, such as in replacements for large signal Power Amplifiers

### Advantageous Features of the Embodiments

As set out in the description above, there are two distinct operating advantages from the use of bi-directional switches such as MOSFETS. The first is the removal of the voltage drop due to current flow through diodes by allowing reverse current through the MOSFET channel when ON.

The second is to do with the ability of the current to flow in both directions and thus the ability of the circuit (theoretically, ignoring losses) to maintain the voltage ratio that is set by the mark to space ratio despite variations in the load, and indeed variations in which the load transforms to a source. Whilst this really is only a single mechanism it can manifest itself operationally in many ways, and it can seem as if there is more than one effect.

A most useful application for explanation is that of a battery supply driving a motor in a road vehicle, where it is part of the desired operation that the motor can behave as a regenerative brake. Here, in the circuit of the first embodiment, a given mark to space ratio drive will determine the ratio between the battery voltage and terminal voltage on the motor under all conditions. On the flat the motor will not be working at full torque and a constant speed will be maintained. If the vehicle comes across an up slope, then current to the motor will increase, but to a first approximation the motor speed will remain constant. If the vehicle starts to roll down the slope (with sufficient slope that other losses are overcome) then the current in the motor will first reduce to zero, then reverse, and the motor will become a dynamo, recharging the battery from the gravitational potential energy of the hill.

The operation of the embodiment of FIG. 1, topology T, is illustrated in FIG. 16, which shows the maintenance of supply and load voltages (at points A and B) for given transistor drive signals over a wide range of operating conditions of the electric vehicle described above. FIG. 16a shows strong regenerative backing with mean current (Iav) greater than half the excitation current (Ie). FIG. 16b shows weaker regenerative braking;, Keith mean current less than half the excitation current. FIG. 16c shows a no load condition, where average current is zero. FIGS. 16d and 16e show weak and strong drive modes, with Iav <0.5 Ie and Iav>0.5Ie respectively. The same transistor drive signals and therefore the same ratio of load voltage to supply voltage are maintained without change in all conditions above.

### Advantages of Use of Bi-Directional Switches, e.g. MOSFETs

1. The absence of diode voltage drops by use of reverse current through turned ON bi-directional switches such as MOSFETs provides significant improvements to power efficiency, and removes one irreducible source of power loss compared with systems using diode conduction.

2. The use of bi-directional switches such as MOSFETS allows the excitation current to go negative, allowing a smooth transition between all phases between full load and full regeneration with only the mark-to-space ratio determining the (theoretical) voltage ratio between source and load (load assumed active or reactive, as in motor or capacitor) (see FIG. 16).

### Switching Delay

It is appropriate to note a particular advantage of implementation with MOSFETs (as an example of a bi-directional switch), which was alluded to in earlier discussions. The synchronous drive condition requires that two semiconductor switches should not be ON simultaneously, as this would lead to very high short circuit currents. However, there is no difficulty with tolerances in practical applications since a small delay between the drive signals to the two switches can be built in. As noted above the circuits described herein can all be implemented with diodes to carry current in the reverse sense, but it is an important element of this invention that power efficiency is improved if such reverse current is instead carried by bi-directional switches. However, if such a switch‘is implemented in parallel with diode, or has an intrinsic diode as in a MOSFET, and if the switch is controlled so as to turn on slightly after the current in the other circuit ceases, then current will have been established in the parallel-connected, or intrinsic (in MOSFETS), diode for a very short time. The power loss associated with the diode's forward voltage drop is then insignificant due to the shortness of the time. Also, the normal semiconductor switching losses, when current and voltage across a semiconductor switch are both in transition (thus dissipating power as IR losses), are avoided by the device that is switching on (as it turns on after the voltage transition has taken place). This advantage is intrinsic to MOSFET implementations (because a MOSFET can be considered as comprising a transistor switch in parallel with an intrinsic diode) but can also be realised by placing a diode in parallel with the other exemplary bi-directional switch elements discussed herein, such as those of FIG. 15.

### Inductor or Transformer Saturation, and Poly-Phase Systems

The above description assumes that the excitation current is small (say 10-20%) of the maximum practical non-saturating flux for the inductor. This is the inventor's current design route. However, as is often the case with current practical DC-DC converters, some designers work on the principle of letting the current decay to zero each cycle. There are two counter strands to the argument. When current is allowed to decay to zero it is argued that the maximum stored magnetic energy is transferred to the load each cycle. Inductance values can be low and ferrite sizes small for a given current. On the whole this route leads to small high frequency designs, perhaps with higher losses. Use of excitation currents that are small compared to peak currents appears to maximise the current that can be transferred to the load. On the whole these lead to larger designs with greater efficiency. In the particular case of DC-DC down converters, load current can be continuous, and it is only the excitation current that injects voltage ripple into the output, and so these ‘current mode’ designs, where excitation current is kept small by comparison to load current are gaining popularity.

In these designs the current is intrinsically intermittent and so an exact parallel between the ‘current-mode’ down converters is not possible, and the advantage of smooth continuous delivery of current to the load not obtainable. Practical designs will range across ratios of excitation to full load currents. Very low excitation currents (say 10%) are useful in low power devices which need to be powered up continuously, since it allows quiescent currents to be kept low. At higher powers the ferrite size reduction of larger excitation currents will become advantageous, but higher current MOSFETS will have frequency limits which become significant sooner. This is a multi-parameter problem that still has elements of black art.

There are also questions of scale and fault tolerance that lead to advantageous designs in either topology in which two or more identical circuits operate in parallel, or partially in parallel (for instance a paralleled output may drive a single motor, but with inputs from separate battery supplies). In such cases the drive phases may be made progressive (for instance if three circuits are used then each maybe 120 degrees out of phase to the others, or 5 circuits may use 72 degrees progressive phase difference) as this minimises current ripple and capacitor sizes it also allows high power systems to be built from a number of identical modules, which may minimise cost by purchase of items at an advantageous unit cost, and offers redundancy and fault tolerance.

### Further Aspects of the Invention

Despite its enormous flexibility, the Topology T circuit embodying the invention does have some disadvantages in certain applications. These are to do with the transformer.

One problem is that this circuit relies on high coupling levels between the primary and secondary circuits. The flux that is linked with one current in one winding at one instant, then has to link with another current in another winding. Some flux will always escape and go a route that does not link with a winding.

Transformers do not have 100% mutual coupling of inductance. This problem occurs because it is not possible to design geometries where all of the flux linked with one circuit is also linked to the other; in general there will always be leakage paths. The problem is exacerbated by the need to provide insulating barriers between windings, and because it is often desirable to build an air gap into a core (this allows higher power levels in a given size of inductor) which can have the effect of increasing the leakage. Whilst it is possible to mitigate the effects by careful design, this cannot be completely eliminated. It is also the case that if an effective electrical solution to the problems is achievable, then larger gaps can be used achieving higher powers.

One model of what this means is to redraw FIG. 1 with parasitic series inductors, as in FIG. 17. When one of the transistor switches is turned ON then the voltage on its Drain terminal is very close to 0V. A simple question is, what is its proper voltage on this terminal when turned OFF? For a 1:1 turns ratio the voltages (in the example of a ‘perfect’ transformer) across the terminals on one side must be the same as on the other side. The MOSFET that is turned ON is imposing the supply voltage V_{S} across the ‘active’ side of the transformer. This, by simple transformer theory, requires the same voltage to appear on the secondary windings, however since the transformer is anti-symmetric, the voltage will be in the opposite sense. The top terminal of the ‘load side’ winding of the transformer is tied to C2 and is thus at voltage V_{L} and so the voltage on the other terminal is this plus the voltage imposed from the ‘active’ side, ie V_{S}+V_{L}. Of course the reverse argument applies when T2 is ON, and it can be seen that both points A and B (drain terminals if using MOSFETS) rise when the switches are OFF to the same voltage V_{S}+V_{L}.

The effect of the uncoupled inductances is to produce voltage swings that are additive to the ‘theoretical’ step voltages described above. Since this happens when the transistor is switched OFF, no current can flow. For this reason relatively small parasitic inductance can produce large voltages. Due to stray capacitance these voltages have the form of a ringing and decaying sine wave.

These voltage excursions are important because they may get close to the Drain-Source voltage rating of a MOSFET, particularly because of the additive effect of the theoretical swing to V_{S}+V_{L}. MOSFETs have a critical practical relationship between rated Drain-Source voltage and resistance when ON, and for a given cost of materials power losses (from IR losses in the MOSFET) will always be lowest for the lowest voltage value MOSFET that is adequate to stand the Drain voltage excursions.

This problem of stray inductance is known in the classic flyback converter of FIG. 12 and the normal protective measure is to put a diode to a clamped protective voltage rail. This works fine, but represents a power loss, and other means are needed to take these circuits to high powers and to avoid the power losses, as described below.

An alternative view of this problem, again with reference to FIG. 17, where each transformer winding is shown with a series parasitic inductance, is as follows. The problems occur when current flowing through one of the transistor switches (in the conventional direction) is switched OFF (note that the case where the transistor is on the load side and reverse current if flowing is different). The current that is being switched is flowing in the uncoupled parasitic inductance of the model in series with the coupled winding. By definition the voltage generated in the coupled part is simply the theoretical value V_{S}+V_{L} (for a 1:1 transformer) as described above. Point A is however a ‘free-end’; its voltage is the theoretical value plus that generated by the parasitic inductance. It is not terminated in DC terms, but has parasitic capacitance to the rest of the circuit, thus instead of the voltage at A rising for ever, it couples to the parasitic capacitance, and point A oscillates (rings) around V_{S}+V_{L}. This oscillation contains up to perhaps a few percent of the energy put into the magnetic circuit whilst the transistor is switched ON, so if it is just allowed to ring and decay then a few percent can be lost from total power efficiency. There is also a bigger practical problem; this voltage is across the Drain/Source of the MOSFET (or other bi-directional switching device), which may only have a limited voltage rating. If the total voltage exceeds this limit then the conductor switch may be destroyed.

It is known to use a snubbing circuit, as in FIG. 18 to protect against this. The positive going voltage excursion is limited by the diode D1 which conducts when the voltage set by Zener diode ZD1 is exceeded. Diode D1 charges capacitor C3 with ringing peaks. Zener diode ZD1 discharges capacitor C2 while keeping the peak voltage at A within the ratings of transistor T1. Note that whilst this stops destruction of the MOSFETs from excess voltage, it does not recover the energy wasted in the uncoupled inductance. Two techniques embodying further aspects of the invention are proposed to counter this.

The first advances the snubber into something that can recover a useful percentage of the energy stored in the uncoupled inductance. An embodiment is shown in FIG. 19. The RH (right hand) part of the circuit is the basic Topology T isolated DC-DC converter described above, and is shown only in outline, although in general, if this technique were to be used then it would be used on both sides. C1 and C2 are the main reservoir capacitors, and T1 and T2 the main switching MOSFETS.

This circuit works if the ringing is such as to generally die away to insignificant levels by the end of a main MOSFET OFF period. Toward the end of this period, the drive to transistor T3 turns on briefly, bringing the voltage on capacitor C4 to equal the ‘true’ OFF voltage (for point A) which is the voltage that there would be if there is no ringing. If there is some ringing at the end of the OFF period then ideally T3 should stay on for a few cycles as connection to C4 will tend to clamp this voltage to the average.

In normal operation ringing pulses at A will conduct through D1, charging capacitor C3. However C3 is made sufficiently large that it takes several (ringing) cycles to charge (it will, on turn on, charge faster whilst its voltage is less than the ‘true’ OFF voltage as it will take energy from the main operation). Diode D1 and capacitor C3 are essentially part of the conventional snubber network. The final part of the operation is to transfer as much of the energy of the ringing as possible back into the supply voltage rail V_{S} at point B. This is done via T4, L1 and D2, which form a conventional down converter. It has already been noted that capacitor C4 is maintained at the ‘true’ OFF voltage for point A, ie the voltage that should be at point A when T1 is off and there is no leakage inductance. For this regenerative snubber to work efficiently the control circuit then switches T4 ON at the time in the cycle when all the ringing has stopped, and OFF when the voltage on C3 has dropped to be approximately equal to the voltage on C4. In this action, at the start of “switch off” ringing for the next cycle, D1 will conduct at just a bit above the voltage on C3, and thus pump all the ringing energy into C3 from the first half cycle of the ringing. FIG. 20 shows the timing waveforms for this action.

This type of regenerative snubber works well, and only adds minor component complexity. Nonetheless the component cost may be significant. This may be the preferred system for higher powers. It may also prove very useful in circuits where the ferrite volume is limited by ‘gapping’ the core. As described above, this allows higher power throughput, but at a cost of higher leakage inductance. This effectively bounces back some of the power that the system attempts to put across the core each cycle. If a system were designed where say 90% of the available transfer energy went across each cycle, and 10% bounced back, but through a 90% efficient regenerative snubber, then an overall 99% theoretical efficiency is still possible.

A second, smaller and neater regenerative snubber design is shown in FIG. 21.

The additional components are transistor T3 and capacitor C3. To understand basic circuit operation, first imagine that T3 is replaced by a short, or that T3 is always switched ON. During the OFF period of transistor T1 the leakage inductance associated with the winding will oscillate with C3. The larger C3 is made, the lower the frequency of the oscillation and the lower the voltage amplitude. By this means alone it is possible to reduce the up swings of voltage at point A to an acceptable level. However this is associated with high power losses because C3 is then completely discharged each cycle when T1 turns on: this generates a simple frequency dependent current that does not contribute to power transfer.

T3 overcomes this problem. It can be turned ON and OFF in anti-phase to the drive to T1. It can be seen that this produces the frequency and amplitude reduction by clamping point A to C3 when T1 is off, but does not allow the DC current flow caused by the discharge of C3 when T1 is ON. However if T3 is left turned ON for the whole of the OFF period of T1 then another effect comes into play. Suppose that the mode of operation is that power is being transferred from left to right, then when T1 is OFF and T2 ON, current is flowing in the secondary side driven by the decay in flux in the winding. In ordinary operation all of the magnetic energy appears in the secondary coil of the transformer, simply because T1 is switched OFF and no current can flow in the primary. However if T3 is switched ON, then current can now flow through the primary windings. The sense of current in the secondary is such as to charge C2, so that in the primary will be such as to discharge C1 and charge C3. Essentially this current is lost from conduction in the secondary circuit. The effect can be minimised by selection of a value of C3 that is a compromise between clamping performance and loss of secondary current. In practice it can be very much improved by limiting the ON time of T3 to the beginning of the OFF period of T1. This means that effective voltage clamping happens at the beginning of Tits OFF period, but the ‘decay’ conduction in parallel with T2 conduction is greatly reduced.

### Isolated Switching Drive Signals

In a further embodiment, with topology T circuits it is possible to build circuit isolators where the control drives to the two sides are also independent. This may be a fixed voltage ratio isolator, or each side may be controlled so as to maintain a fixed voltage. There are many methods by which the necessary control drives could be passed across the isolation barrier (to ensure for instance that both sides do not attempt to conduct at once), for instance using opto isolators, or drive transformers, however it is very convenient and a great simplification if this can be done simply using the main transformer.

Whenever there is some negative excitation current maintained (low load condition above), each transistor is conducting in the conventional sense at the end of its ON period. Thus, when it switches off it causes a voltage transition on the Drain of the other transistor (at point A), and, according to the embodiment, this signal can be detected to start the ON period of the other transistor.

However, when conduction has moved to the high current mode, when the load side transistor switches OFF nothing happens. Conduction continues via the intrinsic diode. The conduction state will only change when T1 is signalled to turn on. The modified snubber circuits of FIG. 21 shows the circuit of FIG. 1 redrawn to show both sides with snubber transistors. In the full load case, control can now be by a different mechanism. Each side of the isolator can now determine its own ON time to match whatever control of output voltage is required, so when the load side controller determines that it is time to end the conduction cycle it can turn T3 off and T4 on. In this situation T4 uses the charge on C4 stored on the previous cycle to pull point B high, basing conduction off in the intrinsic diode of T4 and pulling point A (on the other side of the isolation barrier) low. This now signals that the conduction of T1 should start.

Note here one further factor that is applicable to all of these circuits. In the high current mode, where the load side still has reverse current flowing at the end of its ON period, this current is also flowing in the reverse direction through the parasitic leakage inductance. Its tendency to overshoot is then not with upward but downward first half cycle ringing. The actual voltage excursion seen though will depend on whether the upward step change is initiated by T1 or T4.

In the snubber circuits of the embodiments illustrated above, the high side snubber transistors are all shown as P channel FETS. In general they are handling only a percentage of the power and will be available and cost effective since the drive to them is much simplified. These transistors need to be able to handle current in both directions, and so are preferably MOSFETS or other bi-directional switches. They could be implemented as N channel devices with only a small increase in complexity.

1. An electrical circuit topology for transferring electrical power between a source and a load across an antisymmetric transformer, comprising;
the transformer, having a primary coil and a secondary coil,
first and second bi-directional switches for respectively switchably coupling the primary coil across the source and the secondary coil across the load, and
a controller for controlling synchronous switching of the first and second switches with a predetermined mark-to-space ratio.

2. A topology according to claim 1, which is symmetrical in that power can be transferred in either direction across the transformer.

3. A topology according to claim 1 or 2, in which the primary and secondary coils comprise different numbers of turns.

4. A topology according to any of claims 1 to 3, in which each bi-directional switch comprises a MOSFET.

5. A topology according to any of claims 1 to 3, in which each bi-directional switch comprises two series-connected MOSFETS, two parallel-connected bipolar transistors, or another device of equivalent function.

6. A topology according to any of claims 1 to 5, comprising a regenerative snubber protecting at least one of the bi-directional switches.

7. An electrical circuit topology for transferring electrical power between a source and a load across an inductor, comprising;
the inductor,
a common rail coupling a first voltage terminal of the source to a corresponding first voltage terminal of the load,
first and second bi-directional switches for respectively switchably coupling a first end of the inductor to a second terminal of the source or to the common rail,
third and fourth bi-directional switches for respectively switchably coupling the second end of the inductor to a second terminal of the load or to the common rail, and
a controller for controlling the switches so that, if the source voltage is greater than the load voltage the first switch is on, the second switch is off and the third and fourth switches are synchronously switched with a predetermined mark-to-space ratio; if the source voltage is equal to the load voltage, the first and third switches are on and the second and fourth switches are off; and if the source voltage is less than the load voltage, the third switch is on, the fourth switch is off and the first and second switches are synchronously switched with a predetermined mark-to-space ratio.

8. A topology according to claim 7, in which the circuit is symmetrical such that power can be transferred in either direction across the inductor, from source to load or from load to source.

9. A topology according to claim 7 or 8, in which each bi-directional switch comprises a MOSFET.

10. A topology according to claim 7 or 8, in which each bi-directional switch comprises two series-connected MOSFETS, two parallel-connected bipolar transistors, or another device of equivalent function.

11. An electrical circuit topology substantially as described herein with reference to FIG. 1.

12. An electrical circuit topology substantially as described herein with reference to FIG. 2.
